(19) United States
(12) Patent Application Publication
(10) Pub. No.: US 2024/0021900 A1
(43) Pub. Date: Jan. 18, 2024

(54) METHOD FOR THE HIGH EFFICIENCY RECYCLING OF LITHIUM IRON PHOSPHATE BATTERIES FOR CLOSED LOOP BATTERY PRODUCTION

(71) Applicants: Robert Brian Huang, Las Vegas, NV (US); Richard Brian Huang, Las Vegas, NV (US)

(72) Inventors: Robert Brian Huang, Las Vegas, NV (US); Richard Brian Huang, Las Vegas, NV (US)

(73) Assignee: Watix Technology LLC, Las Vegas, NV (US)

(21) Appl. No.: 18/222,485

(22) Filed: Jul. 17, 2023

Related U.S. Application Data
(60) Provisional application No. 63/389,987, filed on Jul. 18, 2022.

(51) Int. Cl. H01M 10/54; H01M 10/052; C22B 7/00; C22B 1/02

(52) U.S. Cl. CPC H01M 10/54; H01M 10/052; C22B 7/007; C22B 1/02

(57) ABSTRACT

This method recycles lithium iron phosphate batteries to extract cathode active materials, anode active materials, current collector metals, electrolyte, and separator materials in a highly pure state. The process involves the discharging and subsequent disassembly of used batteries into individual components—anode and cathode electrodes, electrolyte, separator, tape, and tabs, achieved via a brine bath, a dimethyl carbonate bath, and physical dismounting. Anode and cathode materials are then separated from their respective current collectors using specific solvent-cosolvent combinations, followed by purification procedures involving washing, heat treatment, and additional purification steps for the cathode. The process results in the extraction of highly pure battery materials including active anode and cathode materials, current collector metals, electrolyte, and separators. This approach obtains and purifies battery materials rather than base elemental compounds, thereby using few chemicals and having high reclamation efficiency, leading to enhanced recovery rates and high purity of resulting materials.

### CROSS-REFERENCE TO RELATED APPLICATION

This application claims the benefit of the U.S. Provisional Patent Application No. 63/389,987, filed Jul. 18, 2022, which is incorporated by reference herein in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present invention relates to the field of chemical processing technology, in particular to the recycling of lithium iron phosphate battery materials.

### Description of Related Art

In recent decades, lithium ion batteries have gained widespread popularity as a method of energy storage due to their high energy density, long storage time, and discharging efficiency. In particular, batteries containing lithium iron phosphate (LiFePO₄, henceforth abbreviated as LFP) cathodes have demonstrated better capacity, voltage, volume density, high temperature stability, and energy cost basis when compared to other cathode types, resulting in their increased participation and demand in technological developments. As the speed of these developments increase, it is expected that there will be substantial amounts of waste LFP batteries. Therefore, a method for recovering the materials within these batteries will be valuable, not only environmentally to reduce the pollution of waste LFP batteries, but also economically to fuel future technological developments.

Most current LFP battery recycling methods include the hydrometallurgical process of acid leach, which may be coupled with solvent extraction, whereby battery components are dissolved in an acid and filtered either with additional solvents or a mesh screen to extract materials. These processes focus primarily on extracting the LFP cathode active material, either as LFP, or separate chemicals of a lithium salt, and a ferric phosphate (and/or an iron and phosphorus compound). These processes tend to produce significant chemical waste, as unwanted or unreclaimable material or solvent is left within the acid or other solvents. Furthermore, these processes tend to ignore the recycling of other materials such as the anode carbon or shell plastic, instead focusing solely on the LFP material or, in some instances, metals that precipitate in manufactured chemical conditions.

Other LFP battery recycling methods involve crushing the battery prior to treatment, which can assist in scalability. Unfortunately, this process causes the extraction of other battery components, such as the current collectors, shell material, or electrolyte, to become difficult, as they are mixed into a disordered pile of materials. This can result in either higher costs from more and complex procedures to extract these materials, or lower recycling efficiency from either declining to reclaim them or reclaiming them with high impurities.

Finally, other methods focus solely on the reclamation of either the anode, cathode, or other LFP battery components, despite utilizing the entire battery at the start of the method. Once again, this can result in either higher costs from more and complex procedures to extract other materials, or lower recycling efficiency from either declining to reclaim them or reclaiming them with high impurities.

### BRIEF SUMMARY OF THE INVENTION

A method for the recycling of LFP batteries to extract cathode active material, anode active material, current collector metals, electrolyte, and separator materials in a highly pure state is presented herein. The recycling process comprises the following steps: (a) the preparation and disassembly of a used LFP battery into its component anode electrode, cathode electrode, electrolyte, separator, high temperature tape, and battery tabs. This process involves an initial discharge step, followed by a bath in dimethyl carbonate media, followed by a drying and physical dismounting step; (b) the separation of the anode electrode into its component current collector and anode active material mix by immersion in a solvent A with cosolvent A solution, followed by a washing step and heat treatment to purify the anode mix; (c) the separation of the cathode electrode into its component current collector and cathode active material mix by immersion in a solvent B with cosolvent B solution, followed by a washing step, addition of additional compounds, a milling step, and heat treatment to re-synthesize and purify the cathode mix.

According to the method for the recycling of LFP batteries of the present invention, since the battery is carefully disassembled, a significant portion of the battery can be reclaimed, including the cathode active material, anode active material, current collectors, electrolyte, separator, high temperature tape, battery shell, and battery tabs, thereby increasing reclamation efficiency. Furthermore, due to the specific solvents used to target the battery components, as well as the purification steps conducted after the extraction of the anode and cathode active material, the collected material is of high purity and can readily be used to produce LFP batteries. Finally, as this method does not use significant amounts of chemicals, nor chemicals that cannot be recycled for further use, this method reduces chemical waste and overall costs.

A method for the recycling of waste LFP batteries is described.

Preferred waste LFP batteries will contain an organic solvent based electrolyte solution, a water-based or an organic-based binder material used to form the coating of the anode, and an organic-based binder material used to form the coating of the cathode. LFP battery current collectors are preferably aluminum and copper, but may include gold thin plate, silver thin plate, and/or platinum.

A water-based binder is a water-soluble binder polymer. Some non-limiting examples of the water-based binder material include styrene-butadiene rubber, acrylated styrene-butadiene rubber, acrylonitrile-butadiene rubber, acryl rubber, butyl rubber, fluorine rubber, polytetrafluoroethylene, polyethylene, polypropylene, ethylene/propylene copolymers, polybutadiene, butyl rubber, fluorine rubber, polyethylene oxide, polyvinylpyrrolidone, polyepichlorohydrin, polyphosphazene, polyacrylonitrile, polystyrene, ethylene/propylene/diene copolymers, polyvinylpyridine, chlorosulfonated polyethylene, latex, polyester resins, acrylic resins, phenolic resins, epoxy resins, polyvinyl alcohol, carboxymethyl cellulose, hydroxypropyl cellulose, and combinations thereof.

An organic-based binder is readily dispersed within an organic solvent, most commonly N-methyl pyrrolidone. Some non-limiting examples of the organic-based binder material include polytetrafluoroethylene, perfluoroalkoxy polymer, polyvinylidene fluoride, copolymer of tetrafluoroethylene and hexafluoropropylene, fluorinated ethylene-propylene copolymer, terpolymer of tetrafluoroethylene, hexafluoropropylene, vinylidene fluoride, and combinations thereof.

The recycling process comprises: (a) the preparation and disassembly of a used LFP battery into its component anode electrode, cathode electrode, electrolyte, separator, high temperature tape, and battery tabs. This process involves an initial discharge step, followed by a bath in dimethyl carbonate media, followed by a drying and physical dismounting step; (b) the separation of the anode electrode into its component current collector and anode active material mix by immersion in a solvent A with cosolvent A solution, followed by a washing step and heat treatment to purify the anode mix; (c) the separation of the cathode electrode into its component current collector and cathode active material mix by immersion in a solvent B with cosolvent B solution, followed by a washing step, addition of additional compounds, a milling step, and heat treatment to re-synthesize and purify the cathode mix.

### Step 1 (Total Battery Process)

Because the waste LFP battery may have charge, the battery is bathed within a salt solution for 2-12 h to discharge it.

In an embodiment, the salt solution is selected from sodium chloride (NaCl), sodium bicarbonate (NaHCO₃), sodium sulfide (N₂S), sodium carbonate (Na₂CO₃), sodium hydroxide (NaOH), potassium bicarbonate (KHCO₃), potassium carbonate (K₂CO₃), potassium hydroxide (KOH), calcium hydroxide (Ca(OH)₂), calcium chloride (CaCl₂)), or any combination thereof. Preferably, the salt solution is sodium chloride, which is cheap.

Preferably, the molar concentration of the salt solution is 1-5M.

After discharging, the battery's shell is disassembled to obtain the cell core.

The cell core should contain the anode electrode, cathode electrode, electrolyte, separator, high temperature tape, and battery tabs. Other structural components may be sorted into casings, packings, safety valves, circuit devices, and/or spacers.

The core is bathed in dimethyl carbonate for 1 h within an nitrogen atmosphere, during which nitrogen is bubbled within the solution to reduce volatile interactions between lithium salts and oxygen and/or moisture. The resulting solution is filtered to obtain the electrolyte filtrate and the cell core residue. The electrolyte filtrate can undergo distillation to reclaim the electrolyte. The cell core is dried at 60-110° C. for 1-2 h and subsequently disassembled into its separator, high temperature tape, metal battery tabs, anode electrode, and cathode electrode.

While dimethyl carbonate is preferred, in an embodiment, it may be replaced by a compound from the group consisting of propylene carbonate, methyl carbonate, ethylene carbonate, ethyl methyl carbonate, acrylonitrile, dimethyl carbonate, or a combination thereof.

### Step 2 (Anode Process)

To separate the anode active material from its current collector, a stripping solution is prepared by mixing a solvent A and cosolvent A. The solvent A dissolves the water-based or organic based binder of the anode, thereby separating the anode active material from its current collector. The cosolvent A is added to remove solid electrolyte interphase lithium based impurities generated during the battery's use, such as lithium carbonate (Li₂CO₃) and/or lithium oxide (Li₂O).

In an embodiment, solvent A is selected from municipal water, pure water, distilled water, hydrochloric acid, or a combination thereof. Preferably, it is pure water. In an embodiment, cosolvent A is selected from an inorganic solvent, such as the non-limitative examples of sulfuric acid, nitric acid, carbonic acid, acetic acid, oxalic acid, citric acid, hypochlorous acid, perchlorate, sodium pyrophosphate, sodium tripolyphosphate, sodium hexametaphosphate, or a combination thereof; or is selected from an organic solvent, such as the non-limitative examples of benzene, toluene, xylene, pentane, hexane, octane, cyclohexane, cyclohexanone, toluene cyclohexanone, chlorobenzene, dichlorobenzene, methylene chloride, methanol, ethanol, propyl alcohol, epoxy propane, methyl acetate, ethyl acetate, propyl acetate, acetone, methyl ethyl ketone, methyl isobutyl ketone, glycol monomethyl ether, ethylene glycol monoethyl ether, glycol monobutyl ether, or a combination thereof. Preferably, it is acetone.

Preferably, the weight ratio of solvent A to cosolvent A is from 99.95:0.05-0.05:99.95.

The anode is bathed in the stripping solution and filtered to extract the anode active material (in the form of fine precipitate), and the current collector (in the form of sheets of metal 6+ microns in any or all dimensions). The collected materials are subsequently dried at 80-200° C. for at least 1 hour.

Preferably, the immersion is carried out under rapid stirring at 40-98° C. for 0.5-3 h. Furthermore, the pH is maintained at 6-8 by addition of deionized water.

The resulting anode mixture is heat treated at 200-800° C. for 1-24 h in a highly pure nitrogen atmosphere to remove any further impurities, remove moisture, and restore the anode mixture structure. The resulting powder is subsequently sifted to reduce clumping.

### Step 3 (Cathode Process)

To separate the cathode active material from its current collector, a stripping solution is prepared by mixing solvent B and cosolvent B. The solvent B dissolves the organic based binder of the cathode, thereby separating the cathode active material from its current collector. The cosolvent B is added to assist in the wettability of the electrode by solvent B, thereby counteracting the high pressed density that cathodes receive during their construction and allowing solvent B to dissolve the binder in an efficient manner.

In an embodiment, solvent B is selected from N-methyl pyrrolidone. In an embodiment, cosolvent B is selected from acetone, tetrahydrofuran, methyl ethyl acetone, methyl ethyl butyl ketone, dimethylformamide, dimethylacetamide, tetramethylurea, dimethyl sulfoxide, trimethyl phosphate, or a combination thereof.

Preferably, the weight ratio of solvent B to cosolvent B is from 99.95:0.05-0.05:99.95.

The cathode is bathed in the stripping solution and filtered to extract the cathode active material (in the form of fine precipitate), and the current collector (in the form of sheets of metal 6+ microns in any or all dimensions). The collected resources are subsequently dried at 80-200° C. for at least 1 hour.

Preferably, the immersion is carried out under rapid stirring at 40-98° C. for 0.5-3 h.

Due to the gradual depletion of lithium ions to side reactions and the solid electrolyte interphase during the cycling of batteries, the resulting cathode mix will not contain an optimal ratio of lithium, iron, and phosphate ratios for maximizing battery capacity. Therefore, the resulting cathode mixture is analyzed to measure its lithium:iron:phosphate ratio, and subsequently uniformly mixed with additional lithium compounds. A carbon compound is also uniformly mixed. The resulting compound is mixed with water. Preferably, the amount of water added makes the system's solid mass percentage equal to 32%. The mixture is milled to a particle size of 300 nm (D50) and subsequently heat treated at 500-800° C. for 1-24 h in a highly pure nitrogen atmosphere. The resulting powder is sifted or crushed to reduce clumping.

In an embodiment, the ratio of lithium:iron:phosphate ions is measured using Inductively Coupled Plasma Atomic Emission Spectroscopy (ICP-AES) analysis or Inductively Coupled Plasma Mass Spectrometry (ICP-MS) analysis.

In an embodiment, the preferred ratio of lithium:iron:phosphate ions is 1.03-1.05:1:1.

In an embodiment, the lithium compound source is selected from the group consisting of lithium acetate dihydrate (CH₃COOLi·H₂O), lithium hydroxide monohydrate (LiOH·H₂O), lithium hydroxide (LiOH), lithium oxalate (Li₂C₂O₄), lithium carbonate (Li₂CO₃) or a combination thereof.

In an embodiment, the carbon compound is selected from the group consisting of glucose, sucrose, cellulose, dextrose monohydrate, polyethlyene glycol, polyvinyl alcohol, soluble starch, monocrystal/polycrystal crystal sugar, fructose, vinyl pyrrolidone, poly(sugar alcohol), polymethacrylate, or a combination thereof, which are soluble and do not contain anion compounds. Preferably, the carbon source is a combination of dextrose monohydrate and polyethylene glycol.

Preferably, the carbon source is in an amount of 0.03-3 mass % of the theoretical lithium iron phosphate.

### BRIEF DESCRIPTION OF THE DRAWINGS

FIG. 1 presents a flow chart that illustrates the steps for the recovery of battery components in an embodiment according to the invention.

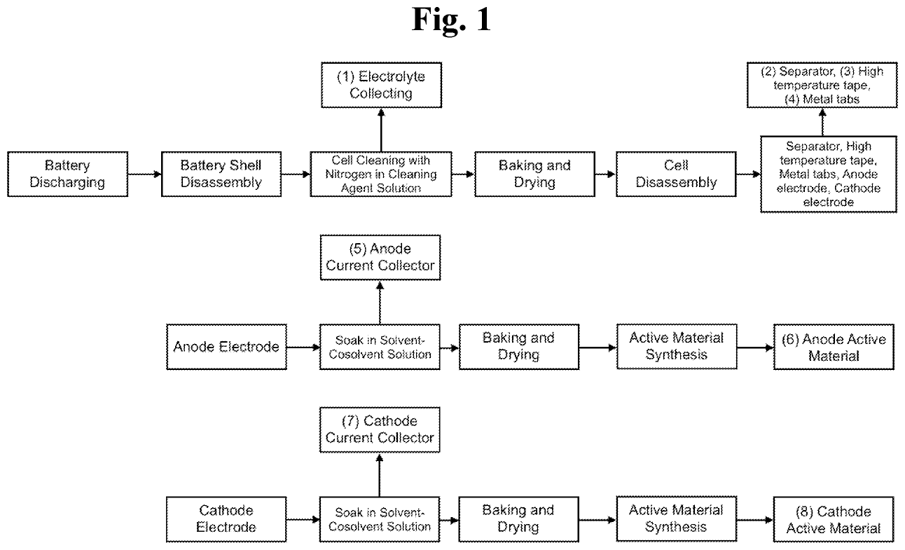

FIG. 2 illustrates the discharge capacity and capacity retention % of a lithium iron phosphate battery manufactured using materials recycled according to an embodiment of the present invention. These measurements are compared to those of a lithium iron phosphate battery manufactured using non-recycled materials.

### DETAILED DESCRIPTION OF THE INVENTION

In order to promote the understanding of the present disclosure, the disclosure will be described below in detail, with reference to the preferred embodiment. It should be understood that the embodiment is merely illustrative, and is not intended to limit the scope of the present disclosure. Any changes, modifications and replacements made by those skilled in the art without departing from the spirit of the disclosure should fall within the scope of the disclosure defined by the claims.

### Assembly of Pouch-Type LFP Battery

### Assembling Positive Electrode

The positive electrode was prepared by mixing 96.5 wt. % LFP material (99.5% purity), 1.5 wt. % carbon black as a conductive agent, and 3 wt. % polyvinylidene fluoride as a binder, which were dispersed in N-methyl pyrrolidone to form a slurry with a solid content of 55 wt. %. The slurry was then uniformly spread onto aluminum foil as a current collector, roll-pressed, and dried at 110° C. for 12 h to obtain a cathode sheet.

### Assembling Negative Electrode

The negative electrode was prepared by mixing 95.8 wt. % of graphite, 2 wt. % styrene-butadiene rubber and 1.2 wt. % carboxymethyl cellulose as a binder, and 1 wt. % carbon black as a conductive agent. The slurry was then uniformly spread onto copper foil as a current collector, roll-pressed and dried at 100° C. for 12 h to obtain an anode sheet.

### Assembling Pouch-Type Battery

After drying, the resulting cathode sheet and anode sheet were cut into rectangular pieces of size 2.5 cm×14.7 cm. The cathode and anode sheets were stacked in an alternating manner and separated by porous polyethylene separators having a thickness of 25 μm. The electrolyte was a solution of 1M lithium hexafluorophosphate (LiPF₆) in a mixture of ethylene carbonate, ethyl methyl carbonate, and dimethyl carbonate in a volume ratio of 1:1:1. The cells were assembled in an atmosphere with a dew point <−45° C.

The assembled batteries were then subjected to repeated charge and discharge cycles at a constant current rate of 1 C between 2.0V and 3.65V to mimic real-life usage patterns. During these cycles, the battery's discharge capacity and capacity retention percentages were measured. Their nominal capacity fell below 80% of its initial rated capacity after 1200 cycles.

### Recycling of Battery

A 13 Ah used lithium-ion battery was fully discharged by soaking in 1 L of 1M sodium chloride (NaCl) solution for 12 h. After discharging, the lithium-ion battery was disassembled and its cell core was extracted. The cell core was immersed into 1 L dimethyl carbonate at 20° C. within an nitrogen atmosphere, during which nitrogen was constantly bubbled. After filtration, the electrolyte was distilled and collected. The cell core was dried at 80° C. for 2 h and subsequently disassembled into its separator, high temperature tape, metal battery tabs, anode electrode, and cathode electrode. The separator, high temperature tape, and metal battery tabs were collected.

The anode was immersed in 1 L of a 98:2 wt. % water to hydrochloric acid solution under rapid stirring for 1 h at 50° C. After drying at 80° C. for 1 h, the copper current collector was reclaimed and the resulting anode mixture was heat treated at 700° C. for 7 h in a high purity nitrogen atmosphere. The resulting powder was subsequently sifted and collected.

The cathode was immersed in 1 L of a 90:10 wt. % N-methyl pyrrolidone to acetone solution under rapid stirring for 1 h at 35° C. After drying at 100° C. for 1 h, the aluminum current collector was reclaimed and the resulting cathode mixture was subjected to ICP-AES analysis, determining the ratio of lithium:iron:phosphate ions to be 0.78:1:1. To compensate, lithium carbonate (Li₂CO₃) was uniformly mixed into the powder to achieve a ratio of lithium:iron:phosphate ions to be 1.02:1:1. A3:1 wt. % mixture of glucose to polyethylene glycol equal to 0.5% of the mass of the lithium iron phosphate was mixed uniformly with the powder as well. The resulting mixture was immersed in water such that the solid weight was 32% and the whole solution was milled to a particle size of 300 nm (D50). The resulting wet powder was heat treated at 700° C. for 7 h in a high purity nitrogen atmosphere. The resulting powder was subsequently sifted and collected.

The recorded yields for the separator (98%), high temperature tape (96%), metal battery tabs (95%), aluminum current collector (97%), copper current collector (98%), anode active material (98%), and the cathode active material (97%) are indicated.

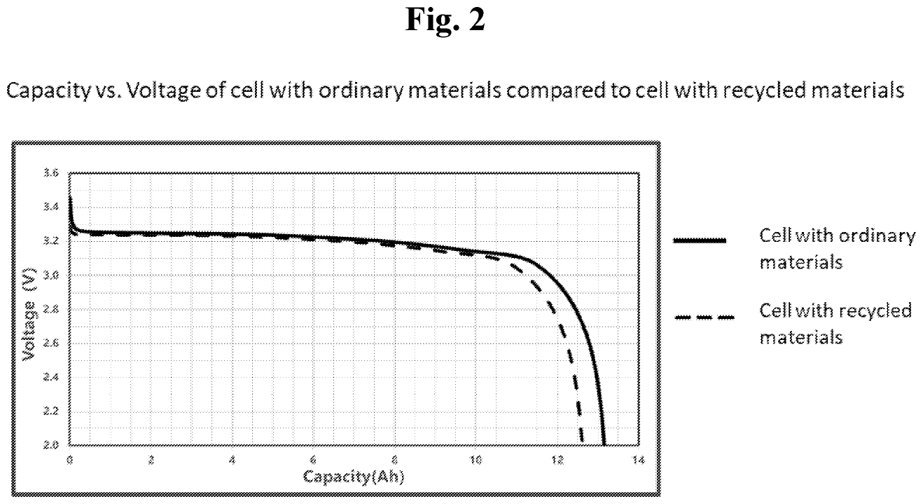

Multiple pouch type LFP batteries were constructed and recycled in the manner described in the example. The recycled material was then used to construct multiple pouch type LFP batteries in a similar manner to the method used to create the original pouch type LFP batteries. These batteries' discharge capacities and capacity retention percentages were measured and averaged. These results are compared to the average capacities and capacity retention percentages of the original pouch type LFP batteries and can be seen in FIG. 2. Evidently, the performance of a LFP battery manufactured using materials recycled according to an embodiment of the present invention has excellent capacity and cycling stability.

1. A method for the recycling of lithium iron phosphate batteries, characterized by the following steps, whereby step (a) is performed first but step (b) and step (c) may be performed in either order or concurrently:
(a) the preparation and disassembly of a LFP battery into its components;
the components of which include the anode electrode, cathode electrode, electrolyte, and separator and may also include high temperature tape, battery tabs, or other structural components of the battery, including casings, packings, safety valves, circuit devices, and spacers;
the preparation and disassembly of which includes discharging the battery, followed by disassembly of the battery's shell, followed by bathing the battery's core in dimethyl carbonate solution, followed by a drying and physical dismounting step to obtain the separated components;
(b) the separation of the anode electrode into its component current collector and anode active material mix, followed by the purification of the anode active material mix;
whereby the separation of the anode electrode is conducted by immersing the anode electrode in a stripping solution that is composed of a solvent and a cosolvent, and then filtering the solution to extract the separated anode active material mix and the separated current collector; the solvent of which is municipal water, pure water, distilled water, hydrochloric acid, or a combination thereof; the cosolvent of which is either an inorganic solvent or an organic solvent;
whereby the purification of the anode active material mix is conducted by having the anode active material mix, that is obtained after the separation, undergo a washing step and a heat treatment step;
(c) the separation of the cathode electrode into its component current collector and cathode active material mix, followed by the purification of the cathode active material mix;
whereby the separation of the cathode electrode is conducted by immersing the cathode electrode in a stripping solution that is composed of a solvent and a cosolvent, and then filtering the solution to extract the separated cathode active material mix and the separated current collector; the solvent of which is N-methyl pyrrolidone; the cosolvent of which is acetone, tetrahydrofuran, methyl ethyl acetone, methyl ethyl butyl ketone, dimethylformamide, dimethylacetamide, tetramethylurea, dimethyl sulfoxide, trimethyl phosphate, or a combination thereof;
whereby the purification of the cathode active material mix is conducted by having the cathode active material mix, that is obtained after the separation, undergo a washing step, the addition of cathode active material mix compounds step, a milling step, and a heat treatment step; whereby the addition of cathode active material mix compounds step of which involves adding lithium and carbon compounds to the cathode active material mix.

2. The method for the recycling of lithium iron phosphate batteries of claim 1, in which, during step (a), dimethyl carbonate is replaced with propylene carbonate, methyl carbonate, ethylene carbonate, ethyl methyl carbonate, acrylonitrile, dimethyl carbonate, or a combination thereof.

3. The method for the recycling of lithium iron phosphate batteries of claim 2, in which, during step (a), during the bathing the battery's core step, nitrogen is bubbled into the solution.

4. The method for the recycling of lithium iron phosphate batteries of claim 1, in which, during step (b), the cosolvent is sulfuric acid, nitric acid, carbonic acid, acetic acid, oxalic acid, citric acid, hypochlorous acid, perchlorate, sodium pyrophosphate, sodium tripolyphosphate, sodium hexametaphosphate, or a combination thereof.

5. The method for the recycling of lithium iron phosphate batteries of claim 1, in which, during step (b), the cosolvent is benzene, toluene, xylene, pentane, hexane, octane, cyclohexane, cyclohexanone, toluene cyclohexanone, chlorobenzene, dichlorobenzene, methylene chloride, methanol, ethanol, propyl alcohol, epoxy propane, methyl acetate, ethyl acetate, propyl acetate, acetone, methyl ethyl ketone, methyl isobutyl ketone, glycol monomethyl ether, ethylene glycol monoethyl ether, glycol monobutyl ether, or a combination thereof.

6. The method for the recycling of lithium iron phosphate batteries of claim 1, in which, during step (b), during immersion, pH is maintained at 6-8.

7. The method for the recycling of lithium iron phosphate batteries of claim 1, in which, during step (b) and step (c) or during step (b) or step (c), the weight ratio of the solvent to the cosolvent is from 99.95:0.05-0.05:99.95.

8. The method for the recycling of lithium iron phosphate batteries of claim 1, in which, during step (b) and step (c) or during step (b) or step (c), immersion is carried out under rapid stirring at 40-98° C. for 0.5-3 h.

9. The method for the recycling of lithium iron phosphate batteries of claim 1, in which, during step (b) and step (c) or during step (b) or step (c), after immersing the electrode in stripping solution, but prior to the purification of the active material mix, the separated current collector and active material mix are dried at 80-200° C.

10. The method for the recycling of lithium iron phosphate batteries of claim 1, in which, during step (c), the lithium compound added is lithium acetate dihydrate (CH₃COOLi·H₂O), lithium hydroxide monohydrate (LiOH·H₂O), lithium hydroxide (LiOH), lithium oxalate (Li₂C₂O₄), lithium carbonate (Li₂CO₃) or a combination thereof, and the carbon compound added is glucose, sucrose, cellulose, dextrose monohydrate, polyethlyene glycol, polyvinyl alcohol, soluble starch, monocrystal/polycrystal crystal sugar, fructose, vinyl pyrrolidone, poly(sugar alcohol), polymethacrylate, or a combination thereof.

11. The method for the recycling of lithium iron phosphate batteries of claim 1, in which, during step (c), during the addition of cathode active material mix compounds step, the ratio of lithium:iron:phosphate ions of the cathode active material mix is initially measured using Inductively Coupled Plasma Atomic Emission Spectroscopy analysis or Inductively Coupled Plasma Mass Spectrometry analysis, and the amount of lithium compound added to the cathode active material mix is an amount that achieves a ratio of lithium:iron:phosphate ions of 1.03-1.05:1:1 within the cathode active material mix.

12. The method for the recycling of lithium iron phosphate batteries of claim 1, in which, during step (c), the mass of carbon added is 0.03-3% the mass of the cathode active material mix.
